(19) United States
(12) Patent Application Publication
(10) Pub. No.: US 2022/0080633 A1
(43) Pub. Date: Mar. 17, 2022

(54) SILICONE MASK WITH REPLACEABLE FILTER ELEMENT AND PREPARATION METHOD THEREOF

(71) Applicant: XIAMEN WAEXIM RUBBER CO.,LTD, Xiamen (CN)

(72) Inventors: Jiashui Lan, Xiamen (CN); Steve Zhong, Xiamen (CN); Jingliu Yang, Xiamen (CN)

(21) Appl. No.: 17/363,349

(22) Filed: Jun. 30, 2021

(30) Foreign Application Priority Data
Sep. 11, 2020 (CN) 202010955302.X

(51) Int. Cl. B29C 45/16; B29C 45/14; B29C 45/00

(52) U.S. Cl. CPC B29C 45/1676; B29L 2031/4835; B29C 45/0001; B29C 45/14336

(57) ABSTRACT

The invention entails a silicone mask with replaceable filter element, including an adjustable strap, a silicone seal ring, a mask framework, a filter element, a face shell and a protective shield. The preparation method is to directly put the adjustable strap, the silicone seal ring, the mask framework, the filter element, the face shell and the protective shield one by one in order. The present disclosure has the advantages of convenient use and easy operation. The length of the strap is adjustable, and the silicone seal ring is made of liquid silicone by molding at one time, which has the characteristics of comfortable wearing and good sealing. The filter element is an embedded structure, which is easy to replace in the process of use, and realizes the recycling of other parts of the silicone mask.

### CROSS REFERENCE TO RELATED APPLICATION

This application claims all benefits from China Patent Application No. CN202010955302.X, filed on Sep. 11, 2020, in the China National Intellectual Property Administration, the content of which is hereby incorporated by reference.

### TECHNICAL FIELD

The disclosure relates to the technical field of silicone masks, in particular to a silicone mask with a replaceable filter element and a preparation method thereof.

### BACKGROUND

With the rapid development of science and technology, the production and living standards of people have been greatly improved, but at the same time, the progress of science and technology has also brought pollution to the environment, for example, air pollution is the most common type. To effectively prevent, wearing masks is a common way. Mask is a kind of protective equipment worn on the mouth and nose to filter the air into the mouth and nose to block harmful gases, odors, droplets, viruses, and other substances. There are mainly two types, namely disposable masks and reusable masks. Disposable masks are usually made of non-woven fabric with a filtering function, which has a low manufacturing cost. However, due to frequent replacement, the use cost is high. The isolation effect of a reusable mask generally depends on the quality of the filter layer (filter element) and the fit degree between mask and face. Although the existing reusable mask can be reused, due to the improper structure design, the preparation process of the components of the mask is complex, the style is fixed, and the filter layer (filter element) is difficult to replace or clean, which affects the production cost, filtering effect and selectivity. Therefore, the development of a silicone mask with a simple preparation process, variable style, and replaceable filter element has an important application prospect.

### SUMMARY

The technical problem to be solved by the present disclosure is to provide a silicone mask with a replaceable filter element and a preparation method thereof.

The present disclosure is realized by the following solution: A silicone mask with a replaceable filter element, including an adjustable strap, a silicone seal ring, a mask framework, a filter element, a face shell, and a protective shield.

The silicone seal ring is made of high transparent liquid silicone as raw material and is formed by coating injection molding, an injection temperature is 125° C. to 135° C., an injection time is twenty-five seconds to forty seconds, and injection pressure is 90 kgf to 110 kgf.

The mask framework is made of high transparent polycarbonate by one-time injection molding, an injection temperature is 280° C. to 300° C., an injection time is two seconds to three seconds, the injection pressure is 100 kgf to 150 kgf, and a cooling time is twenty-two seconds to twenty-five seconds.

The face shell is made of high transparent polycarbonate by one-time injection molding, an injection temperature is 260° C. to 290° C., an injection time is three seconds to five seconds, the injection pressure is 45 kgf to 55 kgf, and a cooling time is fifteen seconds to twenty seconds.

The filter element is an embedded structure, which is convenient to replace during use and can realize the recycling of other parts of the silicone mask.

The surface of the protective shield is produced by the ultraviolet printing process, such that it is easy to achieve personalized customization.

The protective shield is obtained by one-time injection molding with polycarbonate as raw material, an injection temperature is 260° C. to 290° C., an injection time is three seconds to five seconds, the injection pressure is 45 kgf to 55 kgf, and a cooling time is fifteen seconds to twenty seconds.

A preparation method of silicone mask with replaceable filter element includes the steps that are directly putting the adjustable strap, the silicone seal ring, the mask framework, the filter element, the face shell, and the protective shield together one by one in order.

The advantageous effects of the present disclosure are as follows:

1. The preparation method of the silicone mask is that directly putting the adjustable strap, the silicone seal ring, the mask framework, the filter element, the face shell, and the protective shield together one by one in order. In particular, the mask framework and the face shell are connected by way of a buckle, which has the characteristics of convenient use and easy operation.

2. The strap length of the silicone mask is adjustable, and the silicone seal ring is made of liquid silicone by molding at one time, which has the characteristics of comfortable wearing and good sealing. The filter element is an embedded structure, which is easy to replace in the process of use and realizes the recycling of other parts of the silicone mask. At the same time, the protective shield surface of the silicone mask is produced by the ultraviolet printing process, which is easy to achieve personalized customization to print different patterns to meet the requirements of different customers. Further, the protective shield can isolate the contact between the filter element and the environment to a certain extent, effectively extend the service life of the filter element, and broaden the market field of the mask.

### BRIEF DESCRIPTION OF DRAWINGS

FIG. 1 is an exploded view of the present disclosure.

FIG. 2 is a schematic diagram of the front view structure of the present disclosure.

FIG. 3 is a front view structural diagram of a silicone seal ring of the present disclosure.

FIG. 4 is a rear view structural diagram of the silicone seal ring of the present disclosure.

FIG. 5 is a lateral view structural diagram of the silicone seal ring of the present disclosure.

FIG. 6 is a front view structural diagram of a mask framework of the present disclosure.

FIG. 7 is a rear view structural diagram of the mask framework of the present disclosure.

FIG. 8 is a lateral view structural diagram of the mask framework of the present disclosure.

FIG. 9 is a front view structural diagram of a filter element of the present disclosure.

FIG. 10 is a rear view structural diagram of the filter element of the present disclosure.

FIG. 11 is a lateral view structural diagram of the filter element of the present disclosure.

FIG. 12 is a front view structural diagram of the face shell of the present disclosure.

FIG. 13 is a rear view structural diagram of the face shell of the present disclosure.

FIG. 14 is a lateral view structural diagram of the face shell of the present disclosure.

FIG. 15 is a front view structural diagram of a protective shield of the present disclosure.

FIG. 16 is a rear view structural diagram of the protective shield of the present disclosure.

FIG. 17 is a lateral view structural diagram of the protective shield of the present disclosure.

The numbers in the drawings: 1-adjustable strap, 2-silicone seal ring, 3-mask framework, 4-filter element, 5-face shell, 6-protective shield.

### DETAILED DESCRIPTION

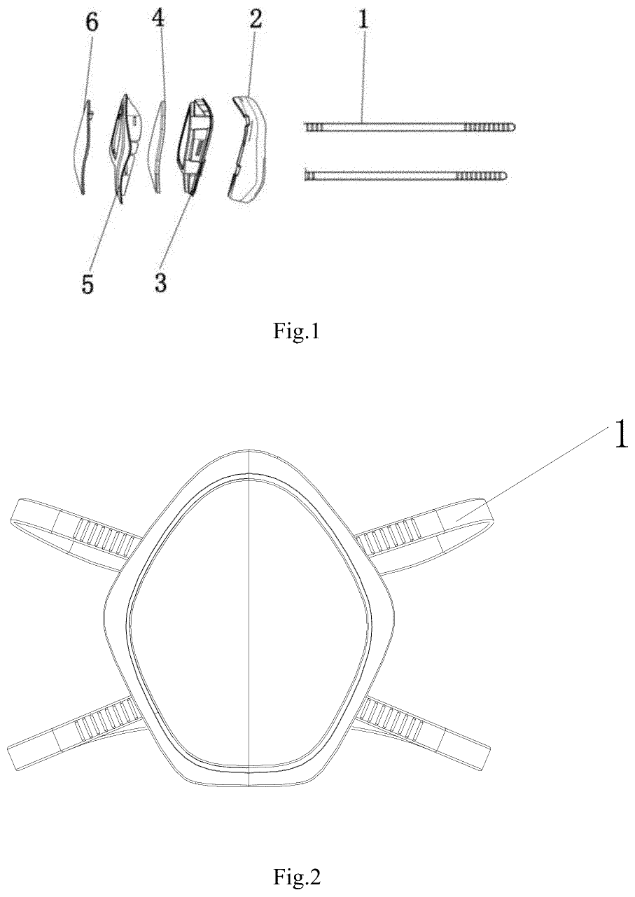

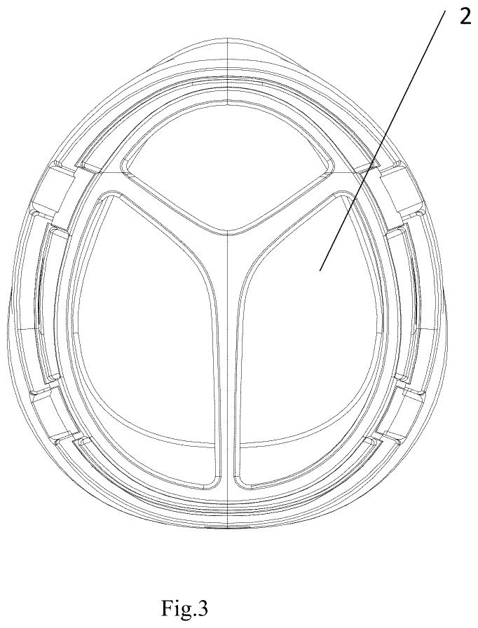

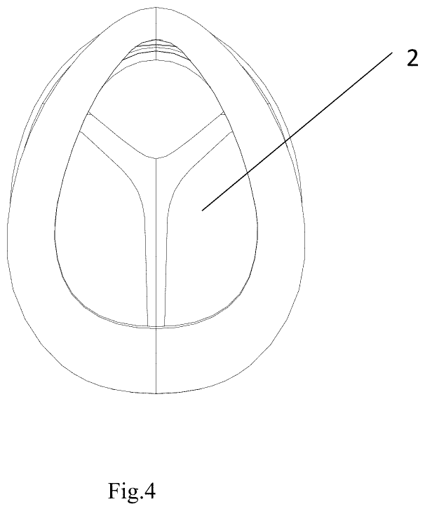

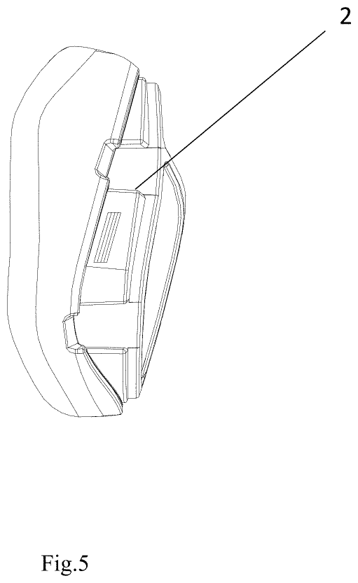

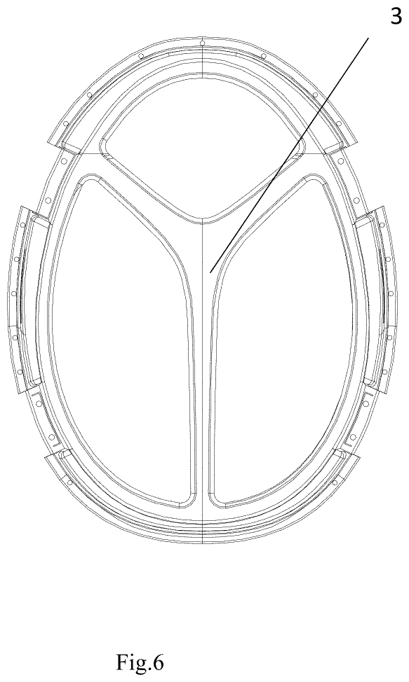

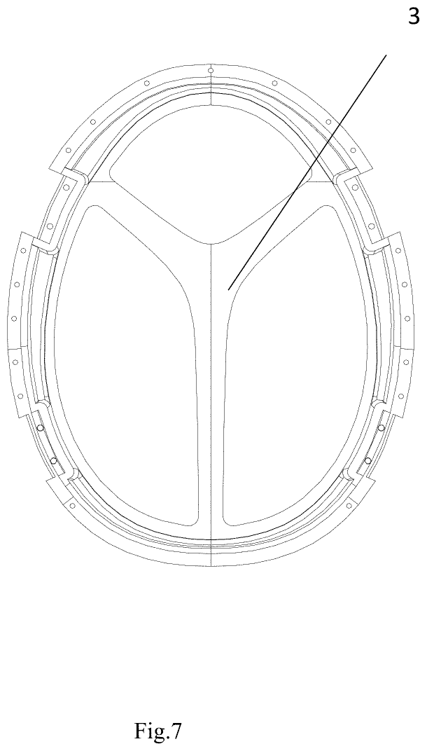

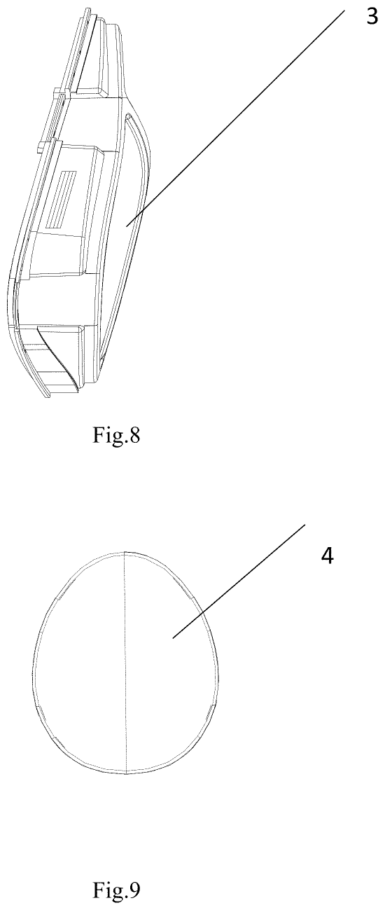

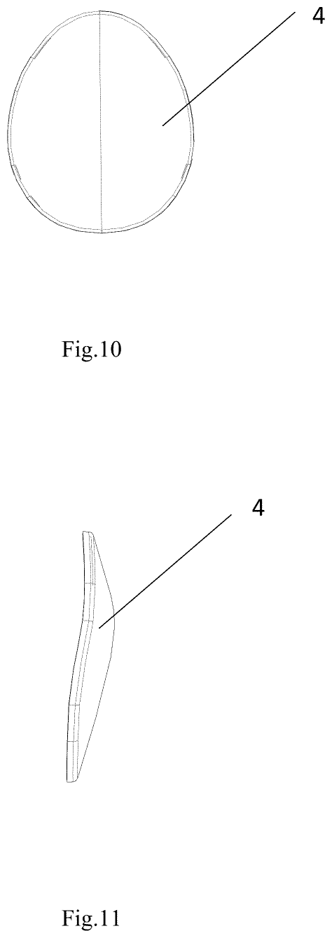

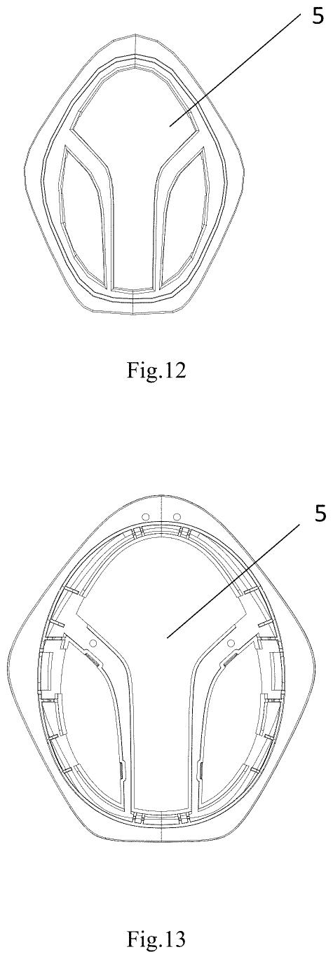

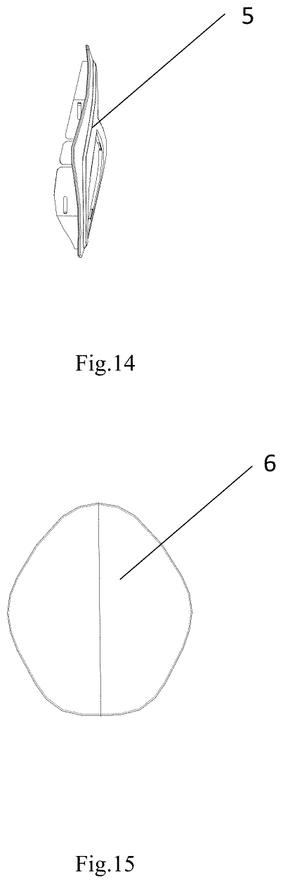

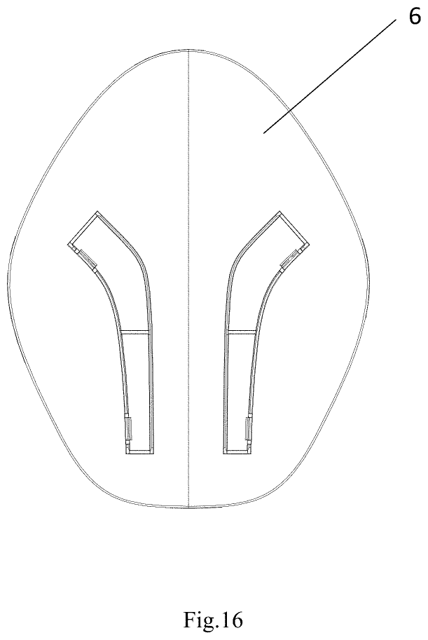

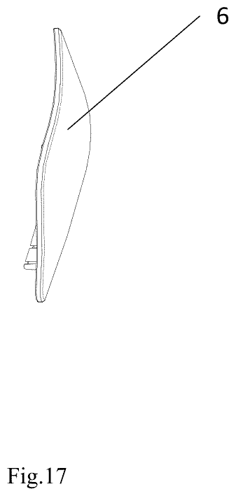

The present disclosure is further described in combination with FIG. 1, but the scope of protection of the present disclosure is not limited to the above contents.

The same components are indicated by the same reference marks. It should be noted that the words “front”, “back”, “left”, “right”, “up” and “down” used in the following description refer to the direction in the figure, and the words “inside” and “outside” respectively refer to the direction towards or away from the geometric center of a specific component. The figure is in a very simplified form and uses an imprecise ratio, which is only used to facilitate and clarify the purpose of the embodiment of the present disclosure.

For the sake of clarity, the well-known functions and structures are not described in detail in the following description because they can cause confusion in the present disclosure due to unnecessary details. It should be considered that in the development of any practical embodiment, a large number of implementation details must be made to achieve the specific objectives of the developer, such as according to the limitations of the relevant system or the relevant business. In addition, it should be considered that such development work may be complex and time-consuming, but it is only routine work for those skilled in the art.

Embodiment 1: A silicone mask with replaceable filter element is composed of adjustable strap 1, silicone seal ring 2, mask framework 3, filter element 4, face shell 5, and protective shield 6. The preparation method is that the adjustable strap 1, silicone seal ring 2, mask framework 3, filter element 4, face shell 5, and protective shield 6 are directly put together one by one in order. The silicone seal ring 2 is made of highly transparent liquid silicone as raw material, and it is obtained by coating injection molding, in which the injection temperature is 125° C., the injection time is forty seconds, and the injection pressure is 110 kgf. The mask framework 3 is obtained by one-time injection molding with polycarbonate as raw material, in which the injection temperature is 280° C., the injection time is three seconds, the injection pressure is 150 kgf, and the cooling time is twenty-five seconds. Filter element 4 is an embedded structure. The face shell 5 is obtained by one-time injection molding with polycarbonate as raw material, in which the injection temperature is 260° C., the injection time is five seconds, the injection pressure is 55 kgf, and the cooling time is twenty seconds. The protective shield 6 is obtained by one-time injection molding with polycarbonate as raw material, in which the injection temperature of 260° C., the injection time of five seconds, the injection pressure of 55 kgf, and cooling time of twenty seconds. At the same time, the surface of the protective shield 6 is made by an ultraviolet printing process.

Embodiment 2: A silicone mask with a replaceable filter element is composed of adjustable strap 1, silicone seal ring 2, mask framework 3, filter element 4, face shell 5, and protective shield 6. The preparation method is that the adjustable strap 1, silicone seal ring 2, mask framework 3, filter element 4, face shell 5, and protective shield 6 are directly put together one by one in order. The silicone seal ring 2 is made of highly transparent liquid silicone as raw material, and it is obtained by coating injection molding, in which the injection temperature is 135° C., the injection time is twenty-five seconds, and the injection pressure is 90 kgf. The mask framework 3 is obtained by one-time injection molding with polycarbonate as raw material, in which the injection temperature is 300° C., the injection time is two seconds, the injection pressure is 100 kgf, and the cooling time is twenty-two seconds. Filter element 4 is an embedded structure. The face shell 5 is obtained by one-time injection molding with polycarbonate as raw material, in which the injection temperature is 290° C., the injection time is three seconds, the injection pressure is 45 kgf, and the cooling time is fifteen seconds. The protective shield 6 is obtained by one-time injection molding with polycarbonate as raw material, in which the injection temperature of 290° C., the injection time of three seconds, the injection pressure of 45 kgf, and a cooling time of fifteen seconds. At the same time, the surface of the protective shield 6 is made by an ultraviolet printing process.

Embodiment 3: A silicone mask with a replaceable filter element (without protective shield 6) is composed of adjustable strap 1, silicone seal ring 2, mask framework 3, filter element 4, and face shell 5. The preparation method is that the adjustable strap 1, silicone seal ring 2, mask framework 3, filter element 4, and face shell 5 are directly put together one by one in order. The silicone seal ring 2 is made of highly transparent liquid silicone as raw material, and it is obtained by coating injection molding, in which the injection temperature is 125° C., the injection time is forty seconds, and the injection pressure is 110 kgf. The mask framework 3 is obtained by one-time injection molding with polycarbonate as raw material, in which the injection temperature is 280° C., the injection time is three seconds, the injection pressure is 150 kgf, and the cooling time is twenty-five seconds. Filter element 4 is an embedded structure. The face shell 5 is obtained by one-time injection molding with polycarbonate as raw material, in which the injection temperature is 260° C., the injection time is five seconds, the injection pressure is 55 kgf, and the cooling time is twenty seconds.

According to GB2626-2016, the silicone masks obtained in the three embodiments were tested (flow rate is 32 L/min), and the relevant results obtained are shown in the following table.

| | | Embodi- | Embodi- | Embodi- |
|---|---|---|---|---|
| item | time | ment 1 | ment 2 | ment 3 |
| Resistance | The first day | 116 | 117 | 111 |
| (Pa) | The second day | 116 | 116 | 112 |
| | The third day | 115 | 116 | 110 |
| | The fourth day | 115 | 116 | 108 |
| | The fifth day | 114 | 115 | 105 |
| | The sixth day | 114 | 114 | 100 |
| | The seventh day | 114 | 114 | 100 |
| 2.5 umBFE | The first day | 99.8 | 99.7 | 99.7 |
| reference | The second day | 99.0 | 98.9 | 97.4 |
| efficiency | The third day | 98.7 | 98.5 | 96.3 |
| (%) | The fourth day | 98.4 | 98.0 | 95.6 |
| | The fifth day | 97.8 | 97.7 | 94.7 |
| | The sixth day | 97.2 | 97.0 | 92.6 |
| | The seventh day | 97.1 | 96.9 | 90.0 |

Embodiment 4: A silicone mask with replaceable filter element is composed of adjustable strap 1, silicone seal ring 2, mask framework 3, filter element 4, face shell 5, and protective shield 6. The silicone seal ring 2 is made of highly transparent liquid silicone as raw material, and it is obtained by coating injection molding, in which the injection temperature is 125° C., the injection time is twenty-five seconds, and the injection pressure is 90 kgf. The mask framework 3 is obtained by one-time injection molding with polycarbonate as raw material, in which the injection temperature is 280° C., the injection time is two seconds, the injection pressure is 100 kgf, and the cooling time is twenty-two seconds. The face shell 5 is obtained by one-time injection molding with polycarbonate as raw material, in which the injection temperature is 260° C., the injection time is three seconds, the injection pressure is 45 kgf, and the cooling time is fifteen seconds. Filter element 4 is an embedded structure. The protective shield 6 is obtained by one-time injection molding with polycarbonate as raw material, in which the injection temperature of 260° C., the injection time of three seconds, the injection pressure of 45 kgf, and cooling time of fifteen seconds. At the same time, the surface of the protective shield 6 is made by an ultraviolet printing process.

Embodiment 5: A silicone mask with a replaceable filter element is composed of adjustable strap 1, silicone seal ring 2, mask framework 3, filter element 4, face shell 5, and protective shield 6. The silicone seal ring 2 is made of highly transparent liquid silicone as raw material, and it is obtained by coating injection molding, in which the injection temperature is 135, the injection time is forty seconds, and the injection pressure is 110 kgf. The mask framework 3 is obtained by one-time injection molding with polycarbonate as raw material, in which the injection temperature is 300° C., the injection time is three seconds, the injection pressure is 150 kgf, and the cooling time is twenty-five seconds. The face shell 5 is obtained by one-time injection molding with polycarbonate as raw material, in which the injection temperature is 290° C., the injection time is five seconds, the injection pressure is 55 kgf, and the cooling time is twenty seconds. Filter element 4 is an embedded structure. The protective shield 6 is obtained by one-time injection molding with polycarbonate as raw material, in which the injection temperature of 290° C., the injection time of five seconds, the injection pressure of 55 kgf, and a cooling time of twenty seconds. At the same time, the surface of the protective shield 6 is made by an ultraviolet printing process.

Embodiment 6: A silicone mask with a replaceable filter element is composed of adjustable strap 1, silicone seal ring 2, mask framework 3, filter element 4, face shell 5, and protective shield 6. The silicone seal ring 2 is made of highly transparent liquid silicone as raw material, and it is obtained by coating injection molding, in which the injection temperature is 130° C., the injection time is thirty seconds, and the injection pressure is 100 kgf. The mask framework 3 is obtained by one-time injection molding with polycarbonate as raw material, in which the injection temperature is 290° C., the injection time is two point five seconds, the injection pressure is 130 kgf, and the cooling time is twenty-three seconds. The face shell 5 is obtained by one-time injection molding with polycarbonate as raw material, in which the injection temperature is 270° C., the injection time is four seconds, the injection pressure is 50 kgf, and the cooling time is eighteen seconds. Filter element 4 is an embedded structure. The protective shield 6 is obtained by one-time injection molding with polycarbonate as raw material, in which the injection temperature of 280° C., the injection time of four seconds, the injection pressure of 50 kgf, and cooling time of seventeen seconds. At the same time, the surface of the protective shield 6 is made by an ultraviolet printing process.

Although the technical solution of the present disclosure has been described and enumerated in detail, it should be understood that it is obvious for those skilled in the art to modify the above embodiments or adopt equivalent alternatives. These modifications or improvements made on the basis without deviating from the spirit of the present disclosure belong to the scope of the present disclosure.

What is claimed is:

1. A silicone mask with a replaceable filter element, comprising an adjustable strap, a silicone seal ring, a mask framework, a filter element, a face shell, and a protective shield.

2. The silicone mask with replaceable filter element according to claim 1, wherein the silicone seal ring is made of high transparent liquid silicone as raw material and is formed by coating injection molding, an injection temperature is 125° C. to 135° C., an injection time is twenty-five seconds to forty seconds, and an injection pressure is 90 kgf to 110 kgf.

3. The silicone mask with replaceable filter element according to claim 1, wherein the mask framework is made of high transparent polycarbonate by one-time injection molding, an injection temperature is 280° C. to 300° C., an injection time is two seconds to three seconds, an injection pressure is 100 kgf to 150 kgf, and a cooling time is twenty-two seconds to twenty-five seconds.

4. The silicone mask with replaceable filter element according to claim 1, wherein the face shell is made of high transparent polycarbonate by one-time injection molding, an injection temperature is 260° C. to 290° C., an injection time is three seconds to five seconds, an injection pressure is 45 kgf to 55 kgf, and a cooling time is fifteen seconds to twenty seconds.

5. The silicone mask with replaceable filter element according to claim 1, wherein the filter element is an embedded structure.

6. The silicone mask with replaceable filter element according to claim 1, wherein a surface of the protective shield is produced by an ultraviolet printing process.

7. The silicone mask with replaceable filter element according to claim 1, wherein the protective shield is obtained by one-time injection molding with polycarbonate as raw material, an injection temperature is 260° C. to 290° C., an injection time is three seconds to five seconds, an injection pressure is 45 kgf to 55 kgf, and a cooling time is fifteen seconds to twenty seconds.
